(19) United States
(12) Patent Application Publication
(10) Pub. No.: US 2016/0098695 A1
(43) Pub. Date: Apr. 7, 2016

(54) ELECTRONIC CONTAINER VENDING PAYMENT CONTROL SYSTEM

(71) Applicant: Air Liquide Advanced Technologies U.S. LLC, Houston, TX (US)

(72) Inventors: Joshua Lavra, Walnut Creek, CA (US); Giuseppe Liberati, Houston, TX (US)

(21) Appl. No.: 14/508,343

(22) Filed: Oct. 7, 2014

(51) Int. Cl. G06Q 20/18; G06Q 20/20; G06Q 20/32; G07F 11/00

(52) U.S. Cl. CPC G06Q 20/18; G07F 11/002; G06Q 20/204; G06Q 20/3224; G06Q 20/3278; G06Q 20/203

(57) ABSTRACT

A payment system for vending containers is provided. The system includes an electronic payment interface accessible by a user and proximate to a container vending machine, comprising an input means, an output means, and a payment module. The input means comprising an electronic interface to an electronic container inventory means, an electronic selection means, at least one of a magnetic card payment interface and an NFC payment interface. The output means comprising an electronic interface to the electronic container inventory means, and the payment module comprising an electronic interface to a microcontroller, the input means, and the output means. A user interfaces with the input means in order to obtain or return a container, and the payment module determines a payment or credit due and interfaces with the user with the output means.

### BACKGROUND

The present invention relates generally to vending and dispensing machines and in particular to such a machine for vending a compressed gas cylinders, such as those used in welding.

Standard pressurized gas cylinders, such as the type typically used for shielding gas for welding and for cutting, pose vending problems. These cylinders have a cylindrically shaped tank, a valve at the top of the tank, and a guard substantially encircling the valve and providing a pair of lifting handles. The guard typically has a diameter smaller than the diameter of the outer surface of the tank. These standard cylinders can be relatively heavy, at least 20 pounds, possibly as heavy as 50 pounds.

It is the common practice for an individual, or small business, to acquire or exchange such pressurized gas cylinders at a store front. This can be inconvenient if the demand arises when the store is not open. Therefore, there is a need in the industry for a means for such small quantity users to obtain such cylinders around the clock, in a convenient and secure manner.

### SUMMARY

A payment system for vending containers is provided. The method includes an electronic payment interface accessible by a user and proximate to a container vending machine, comprising an input means, an output means, and a payment module. The input means comprising an electronic interface to an electronic container inventory means, an electronic selection means, at least one of a magnetic card payment interface and an NFC payment interface. The output means comprising an electronic interface to the electronic container inventory means, and the payment module comprising an electronic interface to a microcontroller, the input means, and the output means. A user interfaces with the input means in order to obtain or return a container, and the payment module determines a payment or credit due and interfaces with the user with the output means.

### BRIEF DESCRIPTION OF THE FIGURES

FIG. 1 illustrates a modular vending unit, with the interior exposed for clarity, in accordance with one embodiment of the present invention.

FIG. 2 illustrates a modular vending unit, with the exterior covering included, to indicate the access means, in accordance with one embodiment of the present invention.

FIG. 3 illustrates an electronic container vending machine in accordance with one embodiment of the present invention.

FIG. 4 illustrates the modular vending unit and the control unit in accordance with one embodiment of the present invention.

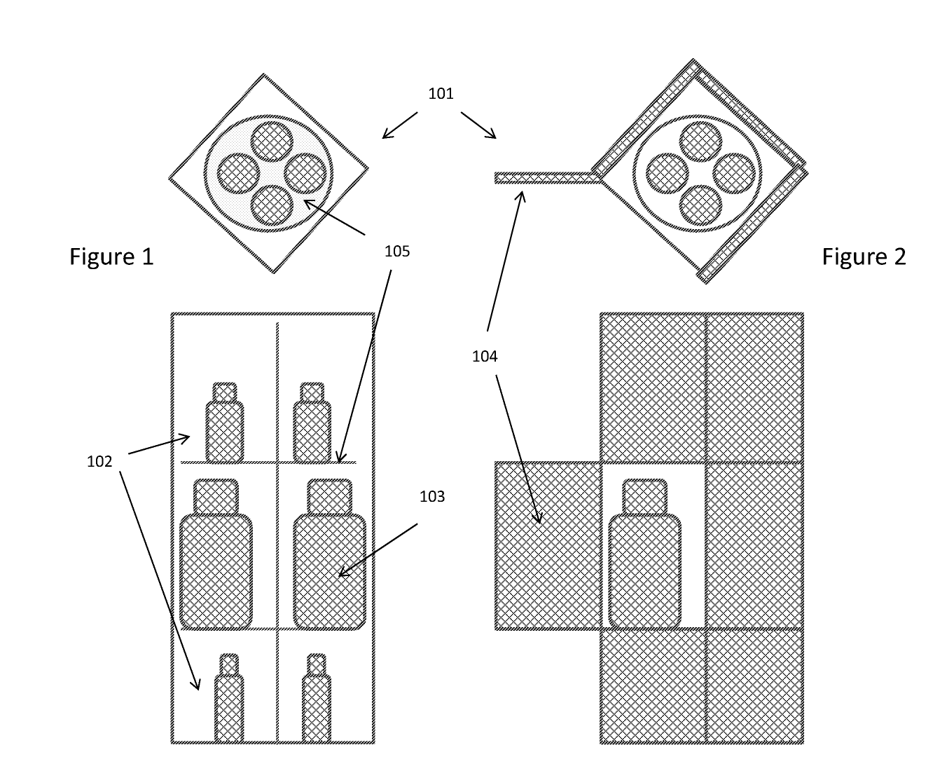

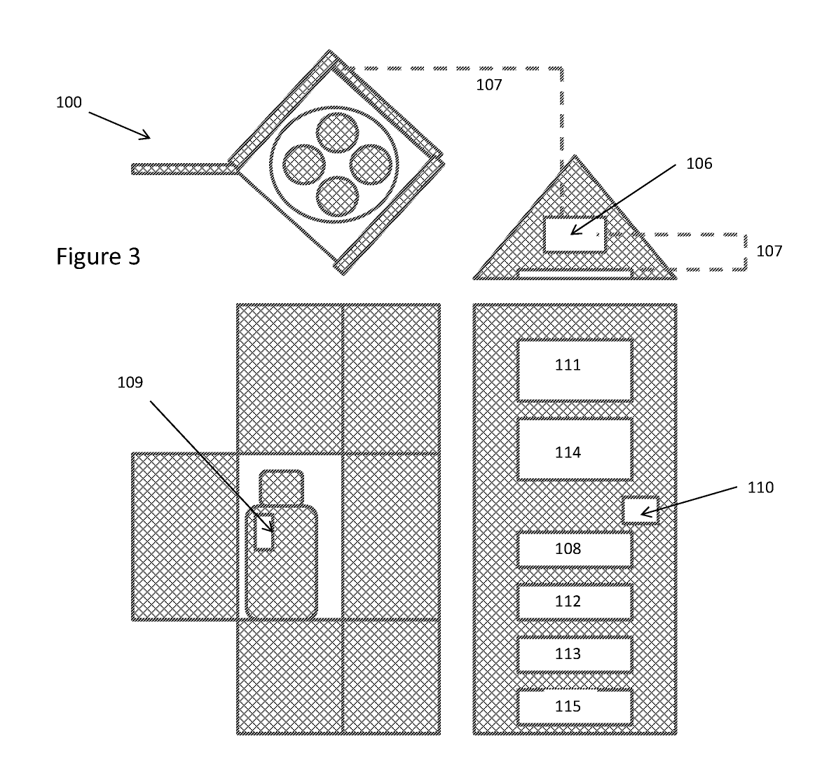

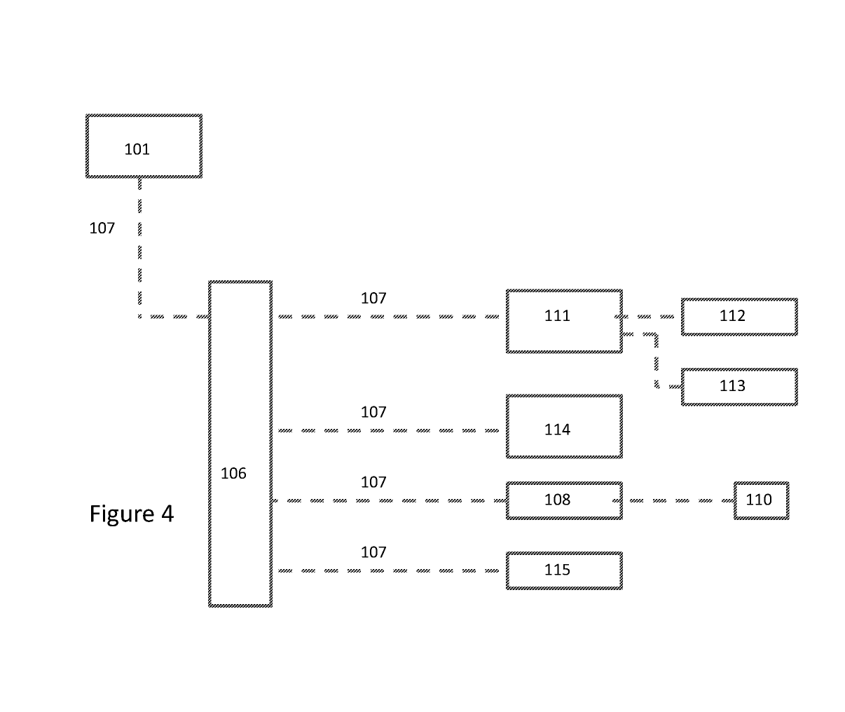

### DETAILED DESCRIPTION

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

### LIST OF ELEMENT NUMBERS

100=container vending machine
101=modular vending unit
102=storage volume
103=single container
104=access means
105=rotatable container storage and dispensing unit
106=control unit
107=input and output means
108=electronic container inventory means
109=RFID tags
110=QR code reader
111=electronic selection means
112=electronic control means for rotating and locking the rotatable container storage and dispensing unit
113=electronic control means for access means
114=electronic payment interface
115=access permission means

One embodiment of the present invention is a payment control method for container vending machines 100 includes at least one modular vending unit 101. This modular vending unit 101 is capable of incrementally rotating and locking in predetermined positions, and includes multiple discrete storage volumes 102 each configured to contain a single container 103. This modular vending also includes an access means 104 for accessing the interior of the rotatable container storage and dispensing unit 105, that is capable of switching between a locked state and an unlocked state, and that is configured to cooperate with the rotatable storage and dispensing unit. The modular vending unit 101 also includes a control unit 106 for communicating with a user and the at least one modular vending unit 101.

The control unit 106 includes an input means and an output means 107, and payment module. The input means 107 may comprise an electronic interface to an electronic container inventory means 108. The input means 107 may comprise an electronic selection means 111, a magnetic card payments interface, an NFC payment system, or both.

The output means 107 may comprise an electronic interface to the electronic container inventory means 108.

The electronic container inventory means 108 may include RFID tags 109 on the available containers. The electronic container inventory means 108 may include a QR code reader 110.

The control unit 106 also includes an electronic selection means 111 configured to allow the acquisition or return of a container, including an electronic control means 112 for rotating and locking the rotatable container storage and dispensing unit 105, and an electronic control means 113 for locking and unlocking the access means 104. The electronic selection device may be a multi-touch screen display. The electronic payment interface 114 may include a credit card payment interface. The electronic payment interface 114 may include an NFC payment interface.

The control unit 106 also includes an electronic payment interface 114 configured to allow for payments or refunds, and an access permission means configured to rotate the rotatable container storage and dispensing unit 105 to a predetermined position, and allow access to the discrete storage volume 102 by modulating the access means 104. The payment module may comprise an electronic interface to a microcontroller, the input means and the output means 107. When as user interfaces with the input means 107, in order to obtain or return a container, the payment module determines the payment or credit due and interfaces with said user by the output means 107.

The containers may be a compressed gas cylinders. The compressed gas cylinders may contain a welding gas mixture. The welding gas mixture may be argon, carbon dioxide, oxygen, helium, nitrogen, or mixtures thereof. The compressed gas cylinder may contain acetylene.

Another embodiment of the present invention is a method of acquiring gas containers from an electronic container vending machine 100. This method includes receiving an input from a user by means of an input device, indicating a desired gas container of a specific size and containing a specific gas composition. Then determining the availability of the desired gas container with an electronic container inventory means 108. Then indicating the availability of the desired gas container to the user by means of an output means. Then receiving a user payment to an electronic payment interface 114. A discount or promotional value may be accepted via QR reader interface. Then delivering the desired gas container through an access permission means 115, thereby rotating a rotatable container storage and dispensing unit 105 to a predetermined position, and switching an access means 104 from a locked state and an unlocked state.

The rotatable container storage and dispensing unit 105 may be capable of incrementally rotating and locking in predetermined positions, including multiple discrete storage volumes 102 each configured to contain a single container 103.

The input device may include an electronic selection means 111 configured to allow the acquisition or return of a container, comprising an electronic control means 112 for rotating and locking the rotatable container storage and dispensing unit 105, and an electronic control means 113 for locking and unlocking the access means 104.

The electronic selection device may include a multi-touch screen display.

The electronic container inventory means 108 may be configured to indicate a quantity of available containers, and a quantity of unoccupied storage volumes 102. The electronic container inventory means 108 may include RFID tags 109 on the available containers. The electronic container inventory means 108 may include a QR code reader 110.

The electronic payment interface 114 may be configured to allow for payments or refunds. The electronic payment interface 114 may include a credit card payment interface. The electronic payment interface 114 may include an NFC payment interface.

The access permission means 115 may be configured to rotate the rotatable container storage and dispensing unit 105 to a predetermined position, and allow access to a discrete storage volume 102 by modulating the access means 104.

In one embodiment of the present invention, one module may house oxygen and other inert gases, while a different module may house acetylene, other combustible gases, and inert gases. The module with the acetylene may be equipped with a lower explosive limit (LEL) meter.

The modules may have provisions for monitoring temperatures and thereby activating ventilation fans under conditions of high ambient or module internal temperatures. Safety alarms may be generated by the system.

1. A payment system for vending containers, comprising;
an electronic payment interface accessible by a user and proximate to a container vending machine, comprising an input means, an output means, and a payment module,
said input means comprising an electronic interface to;
an electronic container inventory means,
an electronic selection means,
at least one of a magnetic card payment interface, and
an NFC payment interface
said output means comprising said electronic interface, comprising an electronic interface to said electronic container inventory means and an access permission means, and
said payment module comprising an electronic interface to a microcontroller, said input means, and said output means
whereby a user interfaces with said input means in order to obtain or return a container, and said payment module determines a payment or credit due and interfaces with said user with said output means, and said access permission means delivers or accepts a desired gas container by rotating a rotatable container storage and dispensing unit to a predetermined position, and switching an access means from a locked state to an unlocked state.

2. The payment system of claim 1, wherein said electronic selection means comprises a multi-touch screen display.

3. The payment system of claim 1, wherein said magnetic card payment interface comprises a credit card payment interface.

4. The payment system of claim 1, wherein said electronic container inventory means comprises RFID tags on the available containers.

5. The payment system of claim 1, wherein said electronic container inventory comprises a QR code reader.

6. The payment system of claim 1, wherein the container is a compressed gas cylinder.

7. The payment system of claim 6, wherein the compressed gas cylinder contains a welding gas mixture.

8. The payment system of claim 7, wherein the welding gas mixture is selected from the group consisting of argon, carbon dioxide, oxygen, helium, nitrogen, or mixtures thereof.

9. The payment system of claim 7, wherein the compressed gas cylinder contains acetylene.
